(19) United States
(12) Patent Application Publication
(10) Pub. No.: US 2018/0200133 A1
(43) Pub. Date: Jul. 19, 2018

(54) DEVICE FOR PRACTICING AND LEARNING A TREATMENT

(71) Applicant: Kappler Med+Org GmbH, Pfalzgrafenweiler (DE)

(72) Inventor: Holger Kappler, Pfalzgrafenweiler (DE)

(21) Appl. No.: 15/870,801

(22) Filed: Jan. 12, 2018

(30) Foreign Application Priority Data
Jan. 13, 2017 (DE) 102017200525.4

(51) Int. Cl. A61G 15/12; A61G 15/08

(52) U.S. Cl. CPC A61G 15/12; A61G 15/14; A61G 15/08

(57) ABSTRACT

A practice device for practicing and learning a medical treatment of a human being may include a torso support and a practice torso arranged on the torso support. The torso support may be arranged on a first adjustment device such that the torso support is adjustable in an adjustment direction.

### CROSS-REFERENCE TO RELATED APPLICATIONS

This application claims priority to German Patent Application No. DE 10 2017 200 525.4, filed on Jan. 13, 2017, the contents of which are hereby incorporated by reference in its entirety.

### TECHNICAL FIELD

The invention relates to a practice device for practicing and/or learning a medical treatment, with a torso support and with a practice torso which is arranged on the torso support.

### BACKGROUND

Practice devices of this kind are used at universities, for example, in order to train students in their craft. Artificial replications of parts of the human body (practice torso) are made available on which the student are able to practice. Depending on the nature of the treatment, it is necessary to adapt the arrangement of utility supports and practice torso depending on whether a left-handed person or a right-handed person is intended to practice the treatment. It is therefore known that the practice torso can be arranged at at least two positions on the practice device. For this purpose, however, a tool is needed with which the practice torso can be removed from a first position and reapplied at a second position.

### SUMMARY

The object of the invention is to make available an improved or at least different design of a practice device which is distinguished in particular by being easier to change between a position for left-handed users and a position for right-handed users.

According to the invention, this object is achieved by the subject matter of the independent claim(s). Advantageous developments are the subject matter of the dependent claims.

The invention is based on the general concept of making available a first adjustment device with which the torso support and therefore the practice torso can be displaced in an adjustment direction. In this way, the position of the practice torso relative to the utility support can be modified, such that it is easy to change over between a position suitable for a left-handed user and a position suitable for a right-handed user.

A favourable option provides that the adjustment devices have rails and slide elements, for example carriages, which can slide along the rails. Such adjustment devices are easy to produce and permit good guiding.

Another favourable option provides that the practice device has at least two holding elements for holding the torso support, which holding elements are arranged at a distance from each other in the adjustment direction. In this way, the torso support can be held in at least two positions. The practice device can thus be fixed in a position suitable for left-handed users (left-hander position) and in a position suitable for right-handed users (right-hander position).

An advantageous solution provides that the holding elements are arranged underneath the first adjustment device in the direction of gravity. In this way, the torso support can be easily suspended in the holding elements, such that the torso support can be fixed and released in a simple manner.

Another advantageous solution provides that the torso support has an engagement element, which can interact with the holding elements, the holding elements have an insertion opening through which the engagement element can be inserted into the holding elements, and the holding elements have at least one holding face which extends transversely with respect to the adjustment direction and which at least limits the movement of the engagement element in the adjustment direction when the engagement element is inserted into the respective holding element.

In particular, the movement of the engagement element in the adjustment direction is blocked by the holding face, such that the torso support is fixed in its position.

A particularly advantageous solution provides that the practice device has a utility support which is arranged adjustably in the adjustment direction on a second adjustment device. Utilities that are required by the person practicing, in particular medial tools, can be made available by the utility support. By virtue of its adjustability, the practice device can be adapted to different persons and different training scenarios.

Another advantageous option provides that the utility support carries a medical tool. Such a medical tool is needed in order to practice the treatment. Such an utility support is usually arranged near the body that is to be treated, such that the person carrying out the treatment has all the necessary utilities and tools within easy reach. Depending on whether the person carrying out the treatment is left-handed or right-handed, it is expedient if the utility support is to the left or right of the person carrying out the treatment. A change-over between a left-hander position and a right-hander position can be achieved by a mirror-image arrangement of the practice torso with respect to the utility support, which, as has already been described, is permitted by the practice device according to the invention.

A particularly advantageous option provides that the utility support carries a dental tool. Specifically in dentistry, it is customary for such an utility support to be arranged next to a treatment chair, which utility support in particular holds or carries a pneumatic drill, a suction device, a fan or the like.

A favourable solution provides that the practice device has a left-hander position and a right-hander position, and that the utility support in the left-hander position is arranged on a first side of the practice torso, and that the utility support in the right-hander position is arranged on a second side of the practice torso opposite the first side. Mirror-image arrangements are thus present in the left-hander position and in the right-hander position, such that, in the left-hander position, left-handed treatment providers can comfortably use the utilities or tools from the utility support and, in the right-hander position, right-handed treatment providers can comfortably reach the utilities or tools from the utility support.

A particularly favourable variant provides that the first adjustment device is arranged above the second adjustment device in the direction of gravity. In this way, a single pivoting movement can ensure that the utility support can be guided past the torso support and that the engagement element can be guided out of the holding elements. The return force induced by gravity can additionally ensure that the engagement element remains in the holding elements when no active force is applied in order to pivot the torso support.

An expedient solution provides that the first adjustment device and the second adjustment device each have a rail, which rails define the adjustment direction, and that the first adjustment device and the second adjustment device each have at least one slide element, which is held adjustably in the adjustment direction on the respective rail. Such adjustment devices permit a rectilinear adjustment movement and thus a linear adjustment direction. Therefore, relatively large distances can be overcome, such that a change-over between the left-hander position and the right-hander position is possible without any problem.

A further expedient solution provides that the rail of the first adjustment device and the rail of the second adjustment device are arranged substantially parallel to each other. It is thus possible to ensure that the adjustment directions of the two adjustment devices have the same orientation.

In the description and in the accompanying claims, “substantially parallel” means that there is an angle deviation of less than 10°.

A particularly expedient solution provides that the first adjustment device has an adjustment path having a length which amounts to at least 60%, preferably at least 80%, of a width of the practice device. In this way, the torso support can be moved sufficiently far from one side of the practice device to the other side of the practice device such that the utility support and the torso support can swap sides.

A favourable variant provides that the torso support is held on the first adjustment device pivotably about a pivot axis. In this way, the engagement element, which is secured on the torso support, can be pulled out of the holding elements. Moreover, the pivoting allows the torso support to be pivoted aside in such a way that the utility support can be guided past the torso support without any problem. This permits a more compact arrangement of the first adjustment device and of the second adjustment device. The torso support can be folded up in order for the utility support to be guided past the practice torso. Thus, the first adjustment device and the second adjustment device can be arranged closer together, such that the practice device as a whole can be made more compact.

A further favourable variant provides that the pivot axis lies substantially parallel to the adjustment direction. In this way, by means of the pivoting movement of the torso support, a movement of the engagement element transversely with respect to the adjustment direction can be achieved, as a result of which the engagement element can be moved very easily out of the holding elements along the holding faces.

An advantageous option provides that the practice torso is a replication of at least part of a body of a living thing, in particular of a human being. In this way, students, in particular students of medicine, can practice carrying out the treatment on an object that is true to life. For example, it is possible to practice a dental treatment, a cosmetic treatment of the skin, or surgical interventions.

The invention is furthermore based on the concept of adapting the practice device to left-handed users and right-handed users by moving the torso support past the utility support by means of the first adjustment device. Therefore, according to the invention, in a method for adapting such a practice device between a left-hander position and a right-hander position, wherein, when viewing a front aspect of the practice device on which the first adjustment device and the second adjustment device are arranged, the utility support is arranged to the left of the torso support in a left-hander position, and the utility support is arranged to the right of the torso support in a right-hander position, when changing between the left-hander position and the right-hander position, the torso support is moved along the adjustment direction past the utility support. In this way, the practice device can be changed over between the left-hander position and the right-hander position without tools.

An expedient option provides that, when changing between the left-hander position and the right-hander position, the torso support is first pivoted about a pivot axis and is thereafter moved past the utility support. In this way, the torso support can be moved past the utility support even when the utility support is actually blocking the path. By means of the pivoting of the torso support, the path required during the movement of the torso support can be displaced such that the torso support can be moved contactlessly past the utility support. Moreover, no tool is needed for this either.

Further important features and advantages of the invention will emerge from the subclaims, from the drawings and from the associated figure description on the basis of the drawings.

It will be appreciated that the features mentioned above and the features yet to be explained below can be used not only in the respectively specified combination but also in other combinations or individually, without departing from the scope of the present invention.

Preferred illustrative embodiments of the invention are shown in the drawings and will be explained in more detail in the following description, wherein identical reference signs relate to identical or similar or functionally identical components.

### BRIEF DESCRIPTION OF THE DRAWINGS

In the drawings, in each case schematically:

FIG. 1 shows a diagram of a practice device in a left-hander position,

FIG. 2 shows a diagram of a practice device in a right-hander position,

FIG. 3 shows a cross-sectional view along the section plane A-A from FIG. 1,

FIG. 4 shows a view corresponding to FIG. 3, wherein a torso support is pivoted,

FIG. 5 shows a view of the region B from FIG. 1, wherein an engagement element is not inserted in a holding element, and

FIG. 6 shows a view corresponding to FIG. 5, wherein the engagement element is inserted in the holding element.

### DETAILED DESCRIPTION

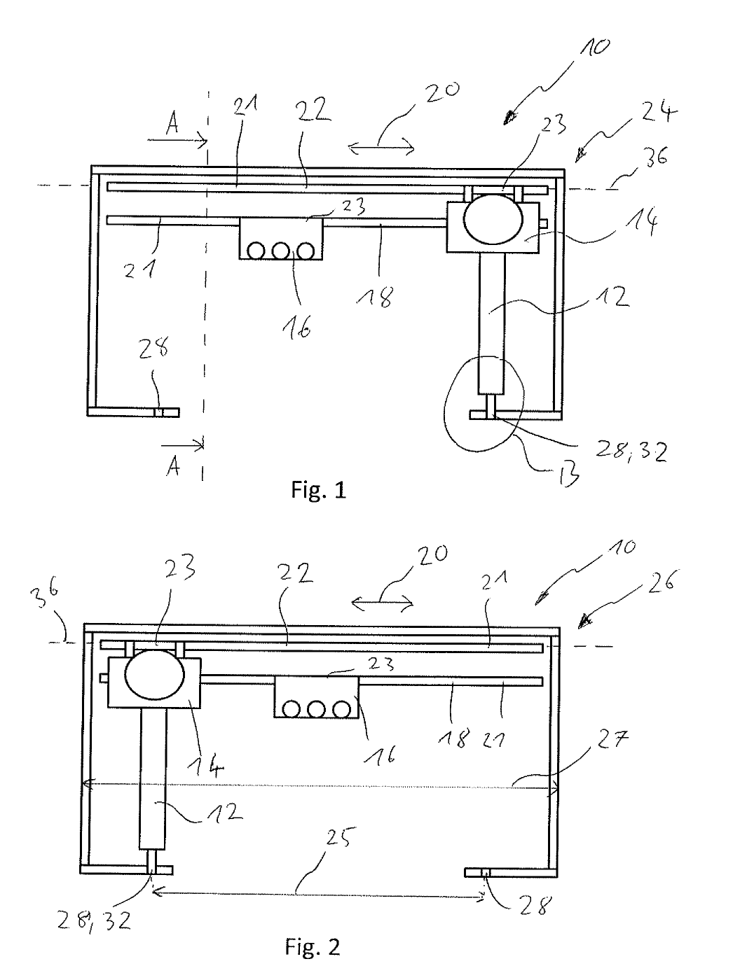

An embodiment of a practice device 10 shown in FIGS. 1 to 6 is used to train medical students, i.e. to help them practice and learn a treatment of a human being. The practice device 10 has a torso support 12 and a practice torso 14 which is arranged on the torso support 12. Moreover, the practice device 10 has a first adjustment device 22, on which the torso support 12 is held. By means of the first adjustment device 22, the torso support 12 is adjustable in an adjustment direction 20. Furthermore, the practice device 10 has an utility support 16, which is held on a second adjustment device 18 and which is likewise adjustable in the adjustment direction 20 by means of the second adjustment device 18.

Preferably, the two adjustment devices 18 and 22 each have a rail 21, which rails 21 define the adjustment direction 20. The rails 21 can be arranged parallel to each other, such that the adjustment direction 20 is the same for both adjustment devices 18 and 22.

Moreover, the adjustment devices 18 and 22 each have at least one slide element 23, for example a carriage, which is held so as to be movable along the respective rail 21. The torso support 12 and the utility support 16 are in turn held on the slide elements 23.

The length of the rails 21 is chosen such that at least the first adjustment device 22, on which the torso support 12 is adjustably held, permits an adjustment path which substantially covers a width of the practice device 10. In particular, the length of the adjustment path is at least 60%, preferably 80%, of the width of the practice device 10.

The utility support 16 carries utilities that are necessary for the treatment, for example tools, in particular medical tools. In the case of a dental treatment, these are, for example, drills, aspirators or the like.

The practice torso 14 is a replication of at least part of a body of a human being. For example, the practice torso 14 comprises a replication of a head, in particular with a lifelike replication of the dentition.

Particularly when practicing a dental treatment, it is important how the utility support 16 is arranged relative to the practice torso 14. Depending on whether the person providing the treatment or the person practicing is left-handed or right-handed, the utility support 16 has to be arranged on one or other side of the practice torso 14. FIG. 1 shows an example of a left-hander position 24. FIG. 2 shows an example of a right-hander position 26. In the left-hander position 24 shown in FIG. 1, the person practicing can use the left hand to remove the utilities from the utility support 16 and can likewise use the left hand to guide the utilities or tool to the practice torso 14 in order to practice the treatment. Correspondingly, in the right-hander position 26 shown in FIG. 2, a right-handed person can use the right hand to remove utilities or tools from the utility support 16 and guide them to the practice torso 14.

In order to fix the torso support 12 and thus the practice torso 14 in the left-hander position 24 or in the right-hander position 26, at least two holding elements 28 are provided, with which the torso support 12 can be held in the corresponding position. The holding elements 28 have an insertion opening 30 through which an engagement element 32 can be inserted into the holding elements 28. Furthermore, the holding elements 28 have a holding face 34 which extends transversely with respect to the adjustment direction 20, such that the holding face forms an abutment and, consequently, the engagement element 32, when inserted into the corresponding holding element 28, is blocked in its movement perpendicularly with respect to the holding face 34, i.e. in the adjustment direction 20. The holding elements 28 designed in this way can thus fix the engagement element 32 in its position.

The engagement element 32 is arranged on the torso support 12, such that the torso support 12 can be fixed in the left-hander position 24 and the right-hander position 26 via the engagement element 32 and the holding elements 28.

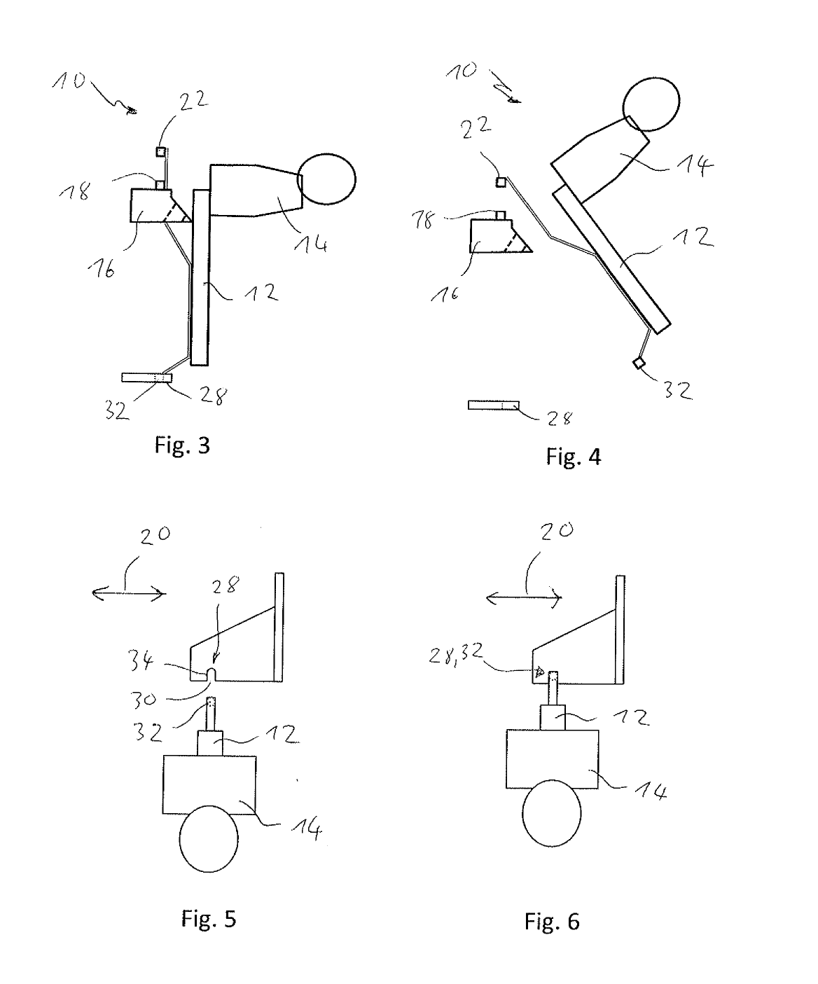

As is shown by way of example in FIGS. 3 and 4, the torso support 12 is held pivotably on the first adjustment device 22, such that the torso support 12 is pivotable about a pivot axis 36. The pivot axis 36 is preferably substantially parallel to the adjustment direction 20. This allows the utility support 16 to be guided past the torso support 12 and also allows the engagement element 32 to be inserted into and removed from the holding elements 28.

As can be seen from FIG. 3 for example, the utility support 16 and the torso support 12 would not pass each other in the adjustment direction 20. Therefore, the outward pivoting as shown by way of example in FIG. 4 is necessary in order to guide the torso support 12 and practice torso 14 past the utility support 16. A compact structure of the practice device 10 can thus be achieved.

The guiding of the engagement element 32 into and out of the holding elements 28 is likewise effected by the pivoting movement about the pivot axis 36, as is shown by way of example in FIGS. 5 and 6. In the position shown in FIG. 5, the engagement element 32 is not inserted into the holding element 28. In the position shown in FIG. 6, the engagement element 32 is inserted into the holding element 28. The holding face 34 thus blocks the movement of the engagement element 32 in the adjustment direction 20.

Overall, the pivoting about the pivot axis 36 and the first adjustment device 22 permits a change-over between the left-hander position 24 and the right-hander position 26 without use of a tool. The torso support 12 can simply be lifted, i.e. pivoted, and guided past the utility support 16. During the pivoting back, the engagement element 32 can be inserted into the holding element 28 and, accordingly, the corresponding position of the torso support 12 can be fixed.

A practice device 10 is thus obtained which can be adapted very easily to different persons. This is of great advantage particularly in teaching, for example at universities for aspiring physicians.

1. A device for at least one of practicing and learning a medical treatment, comprising:
a torso support; and
a practice torso arranged on the torso support;
wherein the torso support is arranged on a first adjustment device such that the torso support is adjustable in an adjustment direction.

2. The device according to claim 1, further comprising at least two holding elements configured to hold the torso support, which, the at least two holding elements arranged at a distance from each other in the adjustment direction.

3. The device according to claim 2, wherein the at least two holding elements are arranged underneath the first adjustment device in a direction of gravity.

4. The device according to claim 2, wherein:
the torso support includes an engagement element interactable with at least one of the at least two holding elements;
the at least two holding elements include an insertion opening through which the engagement element is insertable into the at least one of the at least two holding elements; and
the at least two holding elements include at least one holding face extending transversely with respect to the adjustment direction to at least limit movement of the engagement element in the adjustment direction when the engagement element is inserted into the at least one of the at least two holding elements.

5. The device according to claim 1, further comprising a utility support arranged on a second adjustment device such that the utility support is adjustable in the adjustment direction.

6. The device according to claim 5, wherein the utility support is configured to carry medical tools.

7. The device according to claim 5, wherein the utility support is arranged on a first side of the practice torso when in a left-hander position, and arranged on a second side of the practice torso when in a right-hander position, the second side opposite the first side.

8. The device according to claim 5, wherein the first adjustment device is arranged above the second adjustment device in a direction of gravity.

9. The device according to claim 5, wherein:
the first adjustment device and the second adjustment device each include a rail defining the adjustment direction; and
the first adjustment device and the second adjustment device each include at least one slide element arranged on the respective rail and adjustable along the respective rail in the adjustment direction.

10. The device according to claim 9, wherein the rail of the first adjustment device and the rail of the second adjustment device are arranged substantially parallel to each other.

11. The device according to claim 1, wherein the first adjustment device includes an adjustment path having a length which amounts to at least 60% of a width of the practice device.

12. The device according to claim 1, wherein the torso support is pivotable about a pivot axis.

13. The device according to claim 1, wherein the practice torso is a replication of at least part of a body of a living thing.

14. A method for adapting a device between two positions, comprising:
providing a practice device including a practice torso arranged on a torso support, the torso support arranged on a first adjustment device such that the torso support is adjustable in an adjustment direction, and a utility support arranged on a second adjustment device such that the utility support is adjustable in the adjustment direction, wherein when viewing a front aspect of the practice device the utility support is arranged to the left of the torso support when in a left-hander position and the utility support is arranged to the right of the torso support when in a right-hander position; and
moving the torso support along the adjustment direction past the utility support to change between the left-hander position and the right-hander position.

15. The method according to claim 14, wherein moving the torso support includes first pivoting the torso support about a pivot axis and thereafter moving the torso support past the utility support.

16. The device according to claim 12, wherein the pivot axis extends substantially parallel to the adjustment direction.

17. The device according to claim 13, wherein the living thing is a human being.

18. The device according to claim 9, further comprising at least two holding elements configured to hold the torso support, the at least two holding elements arranged at a distance from each other in the adjustment direction.

19. The device according to claim 18, wherein:
the torso support includes an engagement element interactable with at least one of the at least two holding elements;
the at least two holding elements include an insertion opening through which the engagement element is insertable into the at least one of the at least two holding elements; and
the at least two holding elements include at least one holding face extending transversely with respect to the adjustment direction to at least limit movement of the engagement element in the adjustment direction when the engagement element is inserted into at least one of the at least two holding elements.

20. The device according to claim 19, wherein the torso support is pivotable about a pivot axis.
